(19) United States
(12) Patent Application Publication
(10) Pub. No.: US 2014/0289418 A1
(43) Pub. Date: Sep. 25, 2014

(54) METHODS AND SYSTEMS FOR PLANNING EXECUTION OF AN APPLICATION IN A CLOUD COMPUTING SYSTEM

(71) Applicants: Ira Cohen, Modiin (IL); Ell Mordechai, Modiin (IL); Refael Dakar, Ramat Gan (IL); Ohad Assulin, Tel Aviv (IL); Mark S. Potts, Perth (AU)

(72) Inventors: Ira Cohen, Modiin (IL); Ell Mordechai, Modiin (IL); Refael Dakar, Ramat Gan (IL); Ohad Assulin, Tel Aviv (IL); Mark S. Potts, Perth (AU)

(21) Appl. No.: 14/350,625

(22) PCT Filed: Oct. 10, 2011
(86) PCT No.: PCT/US11/55623

§ 371 Date: Apr. 9, 2014

(51) Int. Cl. H04L 12/24; H04L 29/08

(52) U.S. Cl. CPC H04L 41/0681; H04L 67/1002
USPC 709/226

(57) ABSTRACT

Methods and systems related to planning an execution of an application in a cloud computing system are described herein. The method includes determining whether a workload causes an anomaly associated to the execution of an application. Upon determining that execution of the application under the workload causes an anomaly, an action, or a value of at least one parameter for execution of the application in the cloud computing system, is determined. The action, or the value, is for addressing the anomaly.

### BACKGROUND

A cloud computing system is comprised of multiple pieces of hardware interconnected over a network to perform specific computing tasks such as execution of an application. An application is a computer program designed to facilitate carrying out a specific activity. For example, an E-commerce application may be designed to facilitate access to data related to a product and buying the product. A cloud computing system facilitates scalability of the infrastructure supporting execution of an application. For example, the supporting infrastructure may include a hardware virtualization on a computing platform involving servers, networks and storage. (A hardware virtualization is an emulation of a specific piece of hardware and may serve to facilitate accessing or addressing virtual resources.) The size and configuration of the hardware virtualization may be increased or decreased depending on the computing requirements posed by an execution of the application according to specific parameters. The hardware virtualization may be scaled depending on, for example, number of users, response time, or performance of the involved resources.

The technical characteristics of the infrastructure supporting execution of an application are generally taken into account for deploying the application and, in particular, for calculating deployment costs in a cloud computing system. However, a cloud computing system is complex and scalable. Therefore, it may be difficult to guess how an application may be deployed, or the costs involved for deploying the application.

### BRIEF DESCRIPTION OF THE DRAWINGS

The Figures depict examples, implementations, and configurations of the invention, and not the invention itself.

FIG. 1 depicts an environment in which various examples may be implemented.

FIG. 2 depicts a system according to an example.

FIG. 3 is a block diagram depicting an implementation of the system in FIG. 2.

FIG. 4 is a block diagram depicting an implementation of the system in FIG. 2.

FIGS. 5 to 7 and 9 are flow diagrams depicting steps taken to implement examples.

FIG. 8A depicts a graph illustrating an example of execution of the flow diagram in FIG. 5.

FIG. 8B depicts a table summarizing events taking place during execution of the flow diagram in FIG. 5.

FIGS. 10A to 10C depicts an example of a graphical user interface associated to the system in FIG. 2.

### DETAILED DESCRIPTION

In the foregoing description, numerous details are set forth to provide an understanding of the examples disclosed herein. However, it will be understood by those skilled in the art that the examples may be practiced without these details. While a limited number of examples have been disclosed, those skilled in the art will appreciate numerous modifications and variations therefrom. It is intended that the appended claims cover such modifications and variations as fall within the true spirit and scope of the examples.

The following description is broken into sections. The first, labeled “Environment,” describes an exemplary environment in which various examples may be implemented. The second section, labeled “Components,” describes examples of various physical and logical components for implementing various examples. The third section, labeled as “Operation,” describes steps taken to implement various examples.

### ENVIRONMENT

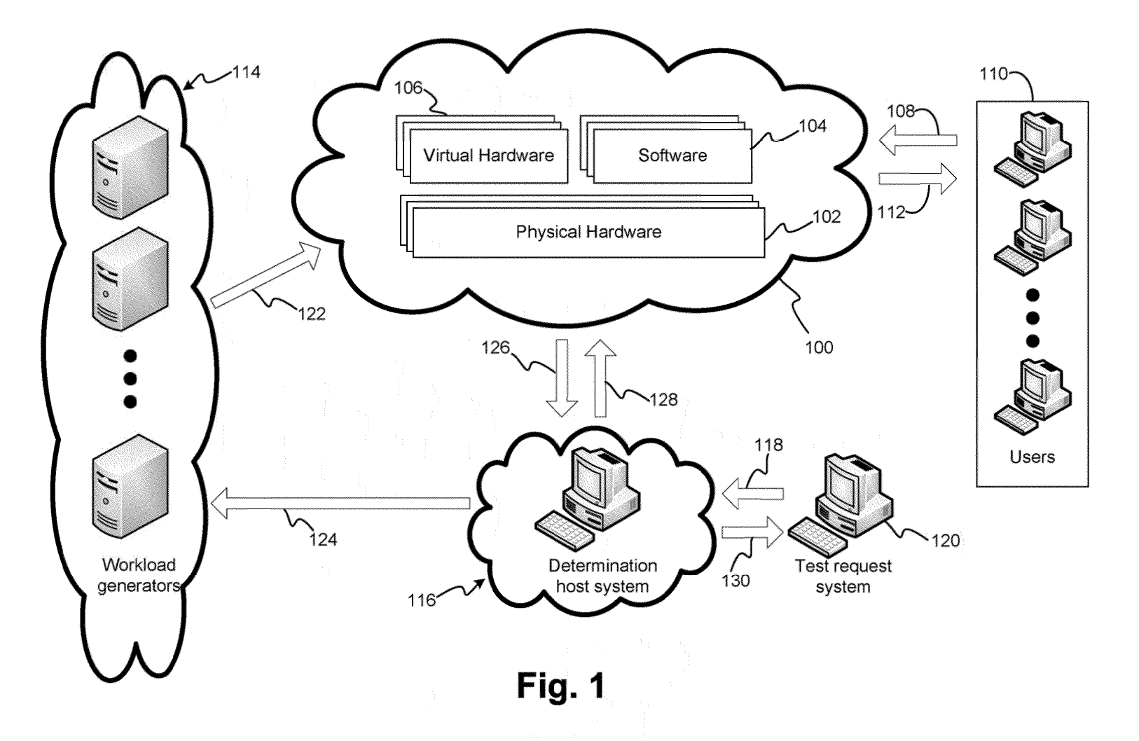

FIG. 1 is a schematic diagram of an example of an environment in which various examples may be implemented. The environment includes a cloud computing system 100 (hereinafter referred to as cloud 100). As used herein, a cloud computing system refers to a computing system including multiple pieces of hardware operatively coupled over a network so that they can perform a specific computing task. Cloud 100 includes a combination of physical hardware 102, software 104, and virtual hardware 106. Cloud 100 is configured to (i) receive requests 108 from a multiplicity of users 110 through application client devices, and (ii) return request responses 112. By way of example, cloud 100 may be a private cloud, a public cloud or a hybrid cloud. Further, cloud 100 may be a combination of cloud computing systems including a private cloud (or multiple private clouds) and a public cloud (or multiple public clouds).

Physical hardware 102 may include, among others, processors, memory devices, and networking equipment. Virtual hardware 106 is a type of software that is processed by physical hardware 102 and designed to emulate specific software. For example, virtual hardware 106 may include a virtual machine (VM), i.e., a software implementation of a computer that supports execution of an application like a physical machine. An application, as used herein, refers to a set of specific instructions executable by a computing system for facilitating carrying out a specific task. For example, an application may take the form of a web-based tool providing users with a specific functionality, e.g., registering to an online service, accessing data related to a product (i.e., browsing), or buying a product. It will be understood that an application as used herein is not limited to an E-commerce application but refers to an application supporting performing a specific task using computing resources such as, among others, enterprise applications, accounting applications, multimedia related applications, or data storage applications. Software 104 is a set of instructions and data configured to cause virtual hardware 106 to execute an application. Thereby, cloud 100 can make a particular application available to users 110.

Executing an application in cloud 100 may involve receiving a number of requests 108 from users 110, process requests 108 according to the particular functionality implemented by the application, and return request responses 112. For executing the application, the resources (e.g., physical hardware 102, virtual hardware 104, and software 106) of cloud 100 may be scaled depending on the demands posed on the application. For example, cloud 100 may vary size of the resources allocated to the application depending on the number of requests, the number of users interacting with the application, or requirement on the performance of the application (e.g., a maximum response time).

Generally, the cost of executing the application in cloud 100 depends on the technical characteristics of the cloud components involved in the execution of the application such as, but not limited to, size of allocated resources, the type of components in the resources, or number and location of instances of the components. Cost calculation may be difficult due to the complex nature of cloud 100. Further, an a priori calculation of the costs may involve an a priori knowledge of the technical characteristics of the involved cloud components. At least some examples described herein facilitate automatically planning costs of executing an application in a cloud computing system.

An implementation includes determining whether a workload causes an anomaly associated to the execution of an application in a cloud computing system under a set of test workloads including a first workload lower than an expected workload.

For example, referring to the environment illustrated in FIG. 1, a set of workload generators 114 may be operatively coupled to (i) cloud 100 and (ii) a determination host system 116. Determination host system 116 may cause performing an automatic planning of costs upon a request 118 of a test request system 120. As illustrated in the figure, workload generators 114 and determination host system 116 may be deployed in a cloud computing system. Alternatively, workload generators 114 and determination host system 116 may be deployed on premise, i.e., run on computers in the premises of the person or organization requesting the automatic planning of costs. Alternatively, workload generators 114 and determination host system 116 may be deployed on premise of a third party performing the automatic planning of costs upon a request of test request system 120.

Workload generators 114 include hardware and software resources configured to emulate users so as to apply a workload 122 on the execution of an application in cloud 100 upon sent of request 124 by determination host system 116. Workload 122 is part of a set of test workloads. Workload 122 is lower than an expected workload, e.g., a workload which is considered to be probable when the application is made accessible to real users. Workload 122 may include at least one of the following specific aspects: (i) a number of users of the application; (ii) a time of use; or (iii) a user behavior. (An example of user behavior for an E-commerce application is that a certain percentage of users only perform browsing associated to the application, another percentage of users perform browsing and buying, a further percentage of users register for using services).

For determining whether workload 122 causes an anomaly associated to the execution of an application, determination host system 116 may monitor execution of the application by sending monitoring request packets 126 to cloud 100 and receiving monitoring information packets 128 from cloud 100. Thereby, determination host system 116 may monitor a set of metrics associated to execution of the application in cloud 100. Upon certain conditions, further illustrated in examples below, the monitored metrics may correspond to an anomaly. For example, an anomaly may correspond to a deviation of the monitored set of metrics from a normal behavior rule that may indicate an abnormal execution of the application in cloud 100. Determination host system 116 may ascertain that the monitored metrics correspond to an anomaly. Alternatively, another system (not shown) may ascertain that workload 122 causes an anomaly and send an anomaly signal to determination host system 116 so that the latter system can determine that workload 122 causes an anomaly.

An implementation further includes, upon determining that execution of the application under a workload of the workload set causes an anomaly, automatically determining an action for execution of the application in the cloud computing system, the action being for addressing the anomaly. For example, determination host system 116 may determine that execution of an application under workload 122 causes an anomaly (e.g., response time of a process associated to the application is too high). Then, determination host system 116 (or another system operatively coupled thereto) may automatically determine an action for executing the application in the cloud computing system that addresses the anomaly. By way of example, determination host system 116 may determine that resetting a VM executing the application and/or allocating a further VM for executing the application addresses the determined anomaly. The determined action may prevent occurrence of the anomaly in a real deployment of the application.

An implementation further includes, calculating a cost of executing the application under the expected workload using the determined action. For example, determination host system 116 (or another system operatively coupled thereto) may calculate the cost of executing the application with the determined action, e.g., using a further VM for executing the application. As set forth below, the above steps may be iterated for varying workloads, so that determination host system 116 can determine a set of actions for addressing anomalies that may occur during execution of an application in cloud 100 under an expected workload. Determination host system 116 may then calculate the cost of executing the application with the determined actions. Determination host system 116 may send a result 130 associated to the automatic cost planning.

In contrast to the above described example, at least some of the known methods and systems merely describe (a) evaluating cloud application development and runtime platforms (see, for example, “Evaluating Cloud Platform Architecture with the Care Framework” by Zhao et al., 2010 Asia Pacific Software Engineering Conference), (b) simulation of applying a provisioning policy (see, for example “CloudAnalyst: A CloudSim-based Tool for Modeling and Analysis of Large Scale Cloud Computing Environments” by Wickremasinghe, 433-659 Distributed Computing Project, CSSE Dept, University of Melbourne, or “Cloudsim a Toolkit for Modeling and Simulation of Cloud Computing Environments and Evaluation of Resource Provisioning Algorithms” Calheiros et al., Software: Practice and Experience, Vol. 41, Issue 1, pp. 23-50, January 2011), or (c) simulation-based methods for finding an optimal control policy “Statistical Machine Learning Makes Automatic Control Practical for Internet Datacenters,” Bodik et al., HotCloud'09 Proceedings of the 2009 conference on Hot topics in cloud computing). The above example facilitates an estimation of costs that takes into account technical characteristics of the resources of a cloud computing system associated to the execution of an application. Further, the above example facilitates preventing the occurrence of anomalies during deployment of an application.

### COMPONENTS

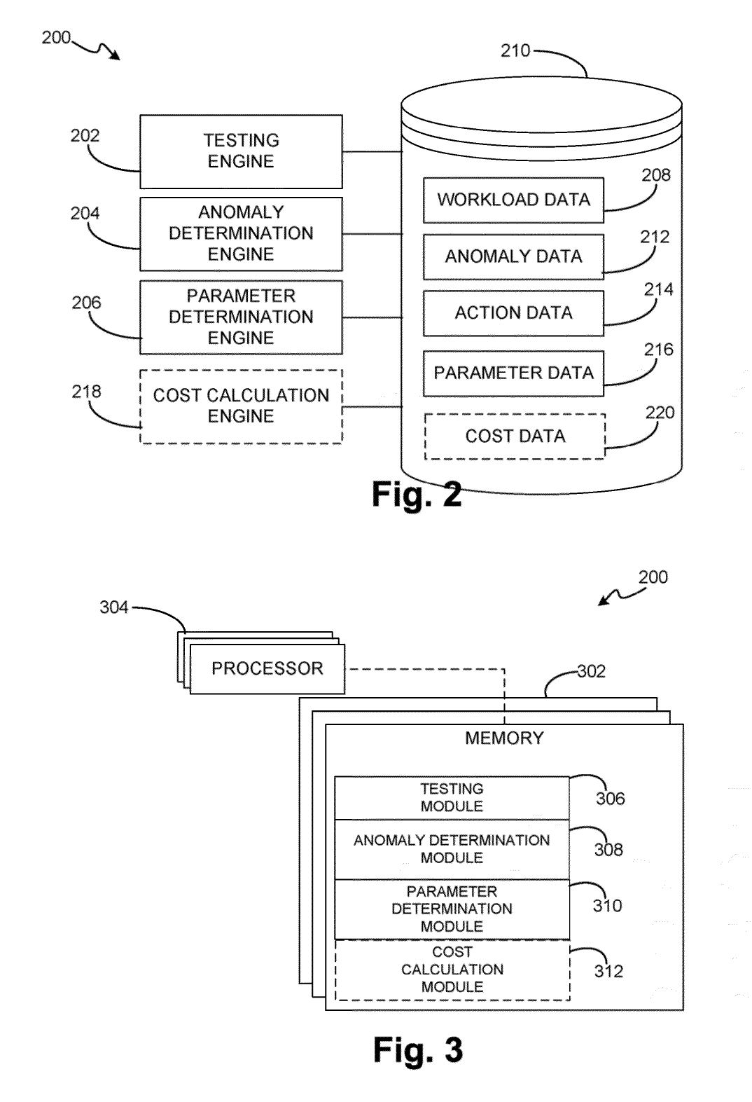

FIGS. 2 to 4 depict examples of physical and logical components for implementing various examples. FIG. 2 depicts a system 200 for automatically determining at least one parameter for executing an application in a cloud computing system (e.g, cloud 100). As used herein, a parameter for executing an application in a cloud computing system may correspond to any variable that can have a specific value during the execution of the application, the value of the variable affecting the execution of the application. By way of example, such variables may include any of the following: (i) type of components used for executing the application (e.g., a web server, an application server, and a database), (ii) number of instances per component, or (iii) the specific configuration of instances (e.g., allocated memory or processing capacity). System 200 includes a testing engine 202, an anomaly determination engine 204, a parameter determination engine 206, and, optionally, cost calculation engine 218.

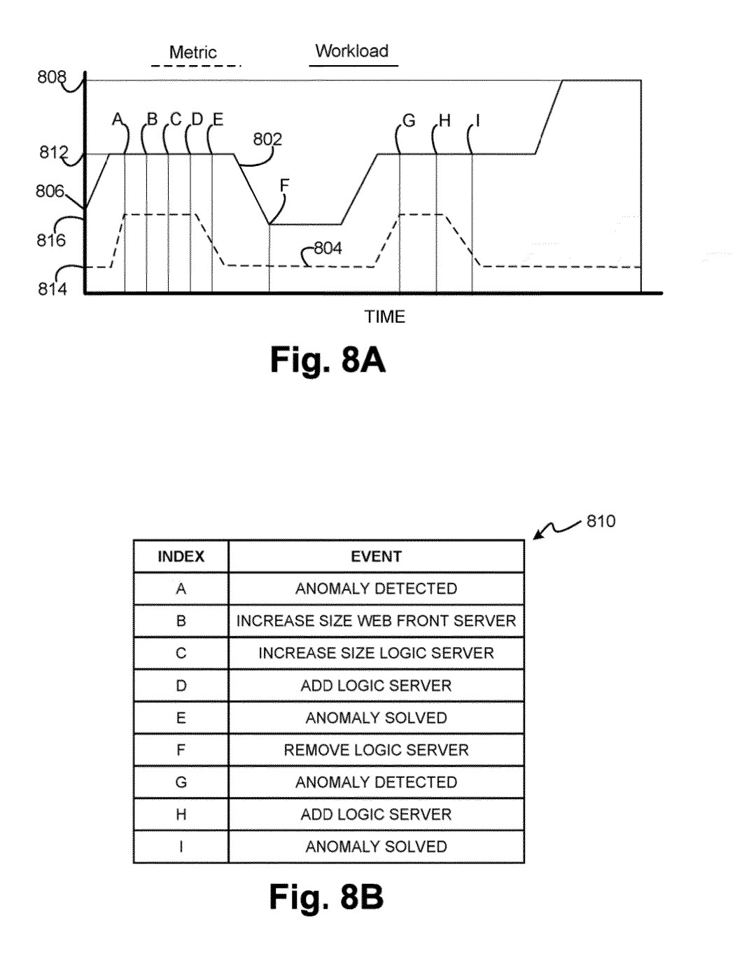

Testing engine 202 represents, generally, any combination of hardware and programming configured to cause execution of the application in a cloud computing system under a set of test workloads. By way of example, the set of test workloads may include workloads increasing from a first workload to the expected workload, as illustrated below with respect to FIG. 8k Testing engine 202 may perform this task by (i) sending a request to cloud 100 to execute the application using a specific set of physical hardware 102, software 104, and virtual hardware 106, and (ii) sending a request 124 to workload generators 114 so as to generate a workload 122, as well as other workloads in the workload set, on the execution of the application in cloud 100. Testing engine 202 may use workload data 208 stored in a data store for causing execution of the application under the workload set. Workload data 208 may include data associated to an expected workload.

According to at least some examples, testing engine 204 may cause executing the application in a sandbox environment. As used herein, a sandbox environment is a testing environment in a cloud computing system isolated from external users. For example, an application may be executed in cloud 100 such that only workload generators 400 and determination host system 116 have access to the application. Thereby, it is prevented that external users (e.g., users 110) may disturb operation of processes as described herein.

Anomaly determination engine 204 represents, generally, any combination of hardware and programming configured to determine whether a workload set causes an anomaly associated to the execution of the application. Anomaly determination engine 204 may perform this task by monitoring, during execution of the application under workloads of the workload set, whether a metric associated to the execution corresponds to an anomaly. Alternatively, anomaly determination engine 204 may process a signal generated by another system for determining that a workload set causes an anomaly associated to the execution of the application. Anomaly determination engine 204 may determine more than one anomaly associated to the workload set. Anomaly determination engine 204 may store information related to determined anomalies as anomaly data 212.

Parameter determination engine 206 represents, generally, any combination of hardware and programming configured to, upon anomaly determination engine 204 determining that execution of the application under a workload of the workload set causes an anomaly, determine a value of at least one parameter associated to execution of the application in the cloud computing system, the value of the at least one parameter being for addressing the anomaly. Parameter determination engine 206 may perform this task by sequentially testing actions selected from a plurality of actions.

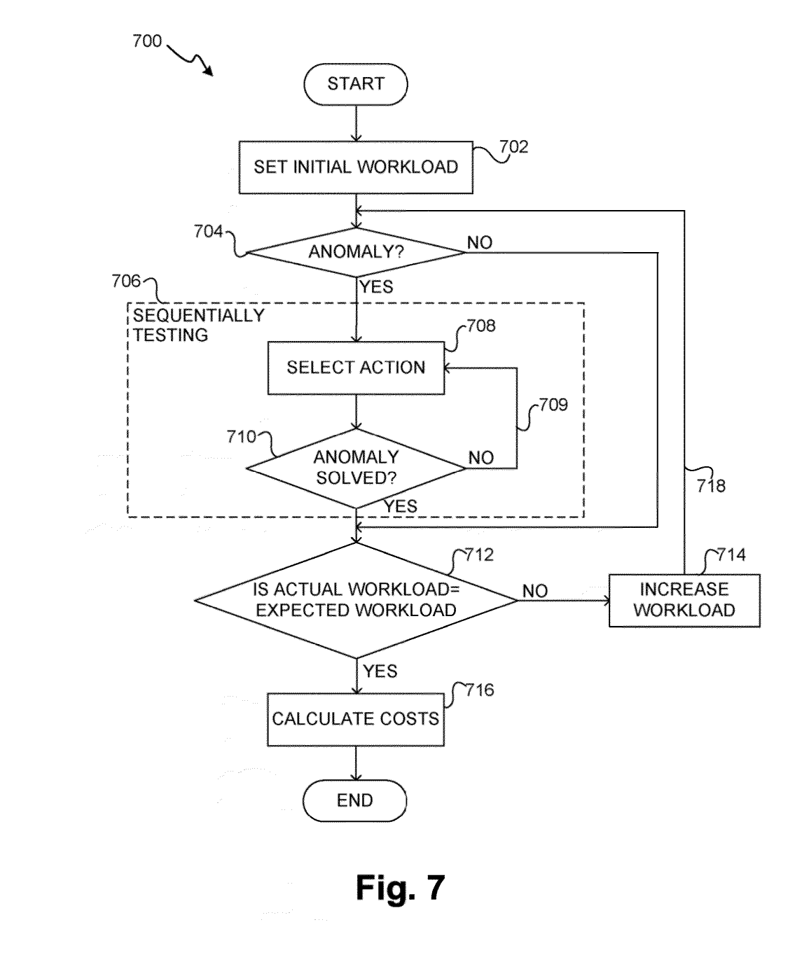

By way of example, parameter determination engine 206 may select an action from a plurality of actions using action data 214 stored in data store 210. One example of action is adding a further instance of a component for executing the application. Parameter determination engine 206 may then determine whether the selected action is appropriate for addressing the anomaly, as further detailed below with respect to FIGS. 7, 8A, and 8B. Upon determining an action appropriate for addressing an anomaly, parameter determination engine 206 may determine parameter values associated to the execution of the application that realizes the determined action. Referring back to the example above, it may be determined that executing an application with a particular numbers of instances of a component (e.g., four instances of a database) addresses the anomaly.

If anomaly determination engine 204 determines more than one anomaly associated to the workload set, parameter determination engine 206 may determine values of at least one parameter that addresses the anomalies. The determined parameter values may be stored in data store 210 as parameter data 216. For example, determination engine 204 may determine an anomaly corresponding to an abnormal long response time of a component, e.g., a web server, and an abnormal high usage of a component, e.g., a database; it may be determined that executing the application using two instances of a web server and four instances of a database addresses both anomalies. Further, parameter determination engine 206 may store in action data 214 that a particular action solved, or not solved, a particular anomaly. The latter may facilitate building a knowledge database for finding an action that addresses a particular anomaly.

System 200 may further include a cost calculating engine 218 configured to calculate a cost of executing the application under the expected workload using the determined value of the at least one parameter. Cost calculating engine 218 may perform this task by evaluating costs associated to execution of an application in cloud 100 using the determined parameter values stored as parameter data 216. The information related to the calculated costs may be stored as cost data 220 in data store 210.

In the foregoing discussion, various components were described as combinations of hardware and programming. Such components may be implemented in a number of fashions. Looking at FIG. 3, the programming may be processor executable instructions stored on tangible memory media 302 (hereinafter referred to as memory 302) and the hardware may include a processor 304 for executing those instructions. Memory 302 can be said to store program instructions that when executed by processor 304 implement system 200 in FIG. 2. Memory 302 may be integrated in the same device as processor 304 or it may be separate but accessible to that device and processor 304.

In one example, the program instructions can be part of an installation package that can be executed by processor 304 to implement system 200. In this case, memory 302 may be a portable medium such as a CD, DVD, or flash drive or a memory maintained by a server from which the installation package can be downloaded and installed. In another example, the program instructions may be part of an application or applications already installed. Here, memory 302 can include an integrated memory such as a hard drive.

In FIG. 3, the executable program instructions stored in memory 302 are depicted as a testing module 306, an anomaly determination module 308, a parameter determination module 310, and a cost calculation module 312. Testing module 306 represents program instructions that, when executed, cause the implementation of testing engine 202 in FIG. 2. Likewise, anomaly determination module 310 represents program instructions that, when executed, cause the implementation of anomaly determination engine 204; parameter determination module 310 represents program instructions that, when executed, cause the implementation of parameter determination engine 206; cost calculation module 312 represents program instructions that, when executed, cause the implementation of parameter determination engine 218.

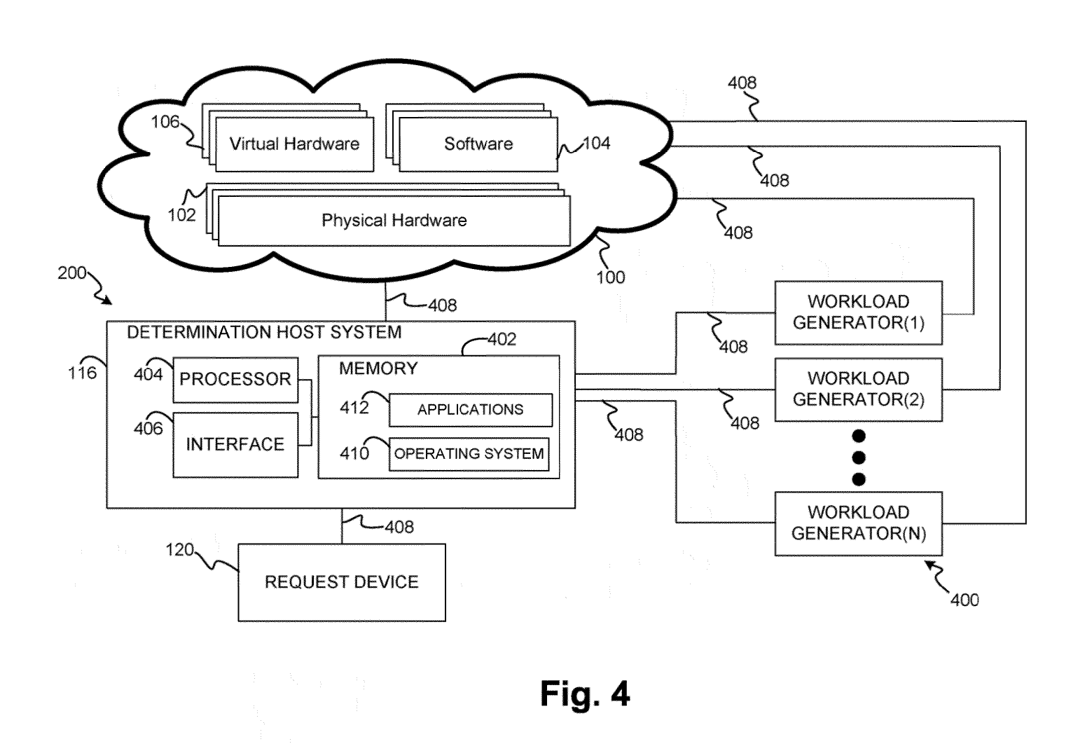

As a further example, FIG. 4 depicts a block diagram illustrating an implementation of the system in FIG. 2. In the shown example, system 200 is implemented by determination host system 116. Determination host system 116 is operatively coupled to request device 120, workload generators 400, and cloud 100 via a network 408.

In the example in FIG. 4, determination host system 116 is shown to include memory 402, processor 404, and interface 406. Processor 404 represents, generally, any processor configured to execute program instructions stored in memory 402 to perform various specified functions. Interface 406 represents, generally, any interface enabling determination host system 116 to communicate with request device 120, workload generators 400, and cloud 100 via network 408.

Memory 402 is shown to include an operating system 410 and applications 412. Operating system 410 represents a collection of programs that, when executed by processor 404, serve as a platform on which applications 412 can run. Examples of operating systems include, among others, various versions of Microsoft's Windows® and Linux®.

Applications 412 represent program instructions that, when executed by processor 404, function as a service that causes automatically determining at least one parameter for executing an application in cloud 100 upon a request from request device 120. Applications 412, when executed, may also function as a service that causes executing the application in cloud 100 under a set of test workloads generated by workload generators 400. Further, applications 412, when executed, may also function as a service that causes determining whether the workload set causes an anomaly associated to the execution of the application. Further, applications 412, when executed, may also function as a service that causes determining a value of at least one parameter associated to execution of the application in the cloud computing system as described herein. Further, applications 412, when executed, may also function as a service that causes calculating a cost of executing the application under the expected workload using the determined value of the at least one parameter.

Looking at FIG. 2, testing engine 202, anomaly determination engine 204, parameter determination engine 206, and cost calculation engine 218 are described as combinations of hardware and programming. Depending on the specific configuration of system 200, the hardware portions may be implemented as processor 404. Depending on the specific configuration of system 200, the programming portions can be implemented by operating system 410, applications 412, or combinations thereof.

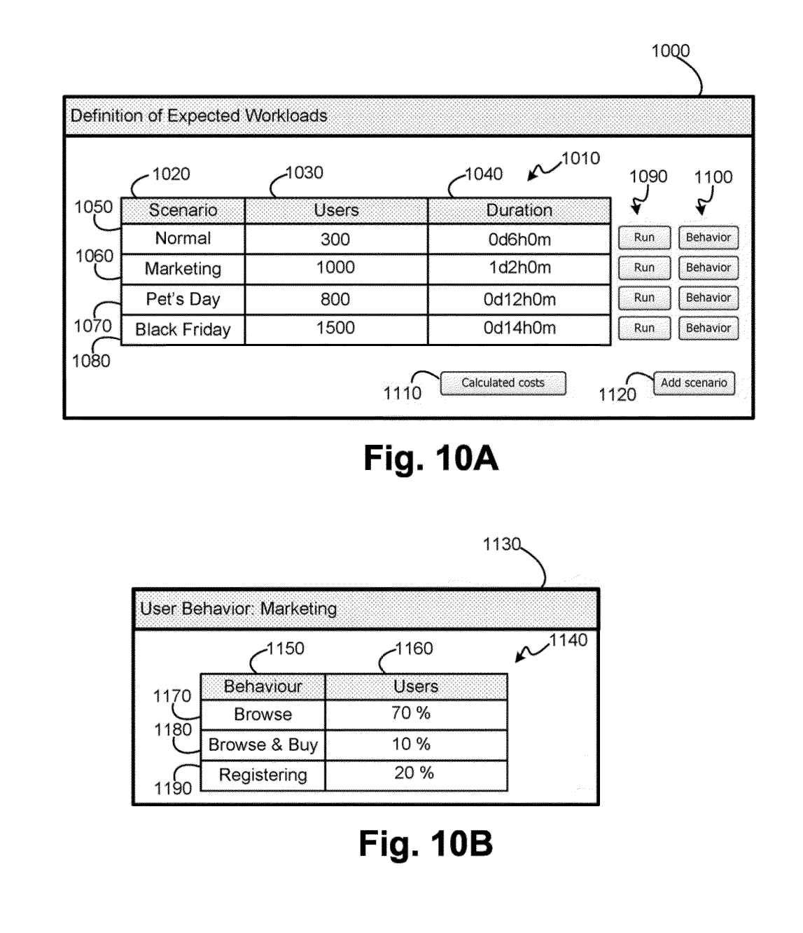

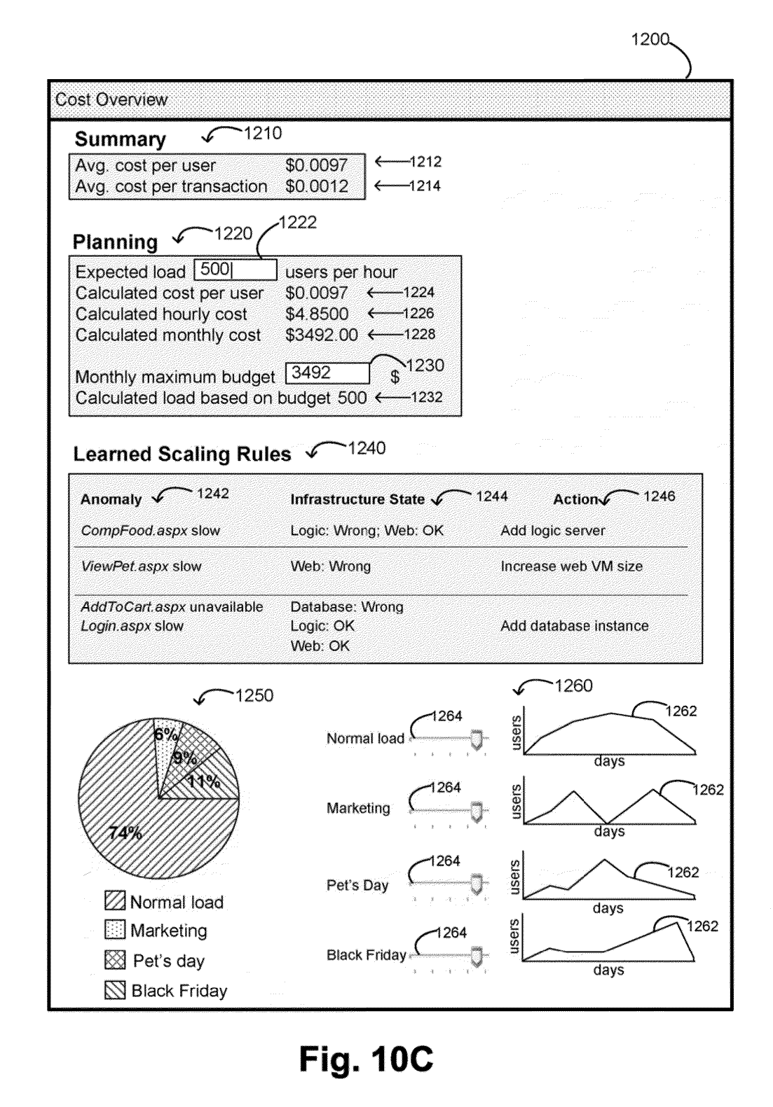

Request device 120 may be implemented as any computing system suitable to (i) communicate with determination host system 116, (ii) generate a request that when processed by determination host system 116, causes a determination of at least one parameter for executing an application in cloud 100 as described herein, (iii) receive a result associated to the request from determination host system 116, and (iv) display information associated to the received result. Generally, request device 120 is configured to execute a graphical user interface (GUI) for receiving and processing an input from a test requester associated to the expected workload of the application to be tested, as further detailed below with respect to FIGS. 10A to 10C. Request device 120 includes a processor, an interface, and a memory (not shown) configured to implement its functions as described herein.

Workload generators 400 are computing devices configured to emulate real users 110 (see FIG. 1). Workload generators 400 generally include a processor, an interface, and a memory (not shown) configured to implement its functions as described herein. A workload generator may be configured to emulate multiple users. Further, workload generators may be configured to communicate with cloud 100 through network 400 using different communication protocols such as, but not limited to, Web HTTP/HTTPS, Remote Terminal Emulator, Oracle or Web Services for emulating real users. In some example, workload generators 400 may be a single machine with sufficient capacity to generate a particular workload corresponding to multiple users.

### OPERATIONS

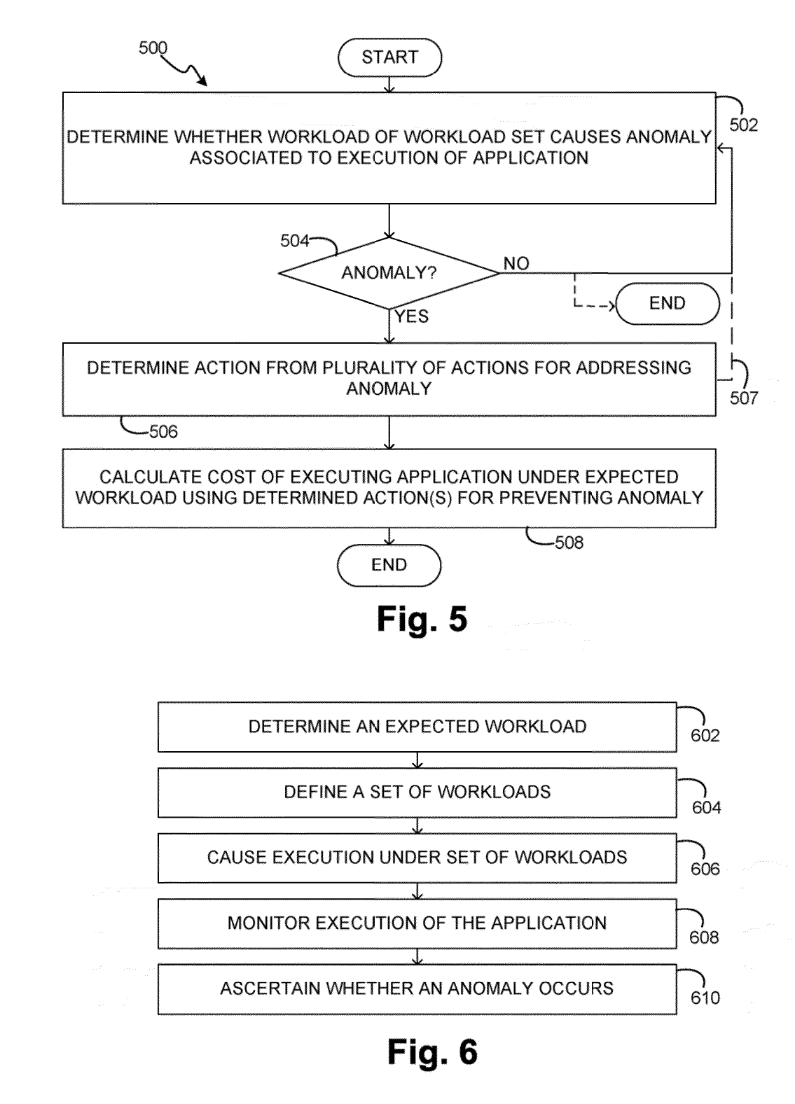

FIGS. 5 to 7 and 9 are exemplary flow diagrams of steps taken to implement examples of methods for automatically planning costs of executing an application in a cloud computing system. In discussing FIGS. 5 to 7 and 9, reference is made to the diagrams in FIGS. 1-4 to provide contextual examples. Implementation, however, is not limited to those examples. Reference is also made to the examples depicted in FIGS. 8A, 88, 10A to 10C. Again, such references are made simply to provide contextual examples.

Referring now to FIG. 5, a process flow 500 includes a step 502 of determining whether a workload causes an anomaly associated to the execution of an application in a cloud computing system under a set of test workloads including a first workload lower than an expected workload, Referring back to FIG. 2, testing engine 202 and anomaly determination engine 204 may be responsible for implementing step 502.

Referring now also to FIG. 6, step 502 includes a sub-step 602 of determining, an expected workload for performing a test on the execution of a specific application in cloud 100. In an example, request device 120 receives input data from a requester through a suitable GUI. The input data is associated to an expected workload. This input data may include a script defining an expected workload including different scenarios. By way of example, a scenario may be comprised of a number of users employing the application, duration of scenario, and a specific user behavior. Determination host system 116 may receive such data from request device 120 for determining the expected workload. In another example, determination host system 116 is configured for enabling a requester to directly input data associated to an expected workload or to automatically define an expected workload. In an example further set forth below, data associated to an expected workload is automatically determined by monitoring actions of testers employing the application.

Looking ahead to FIG. 10A, a GUI 1000 is an example of a GUI for defining expected workloads. More specifically, GUI 1000 is for defining expected workloads of an E-commerce shop application related to products for pets. In GUI 1000 (and other GUIs shown herein) non-editable fields are indicated by a grey filling; editable fields are indicated by a blank filling.

GUI 1000 may include a table 1010 with columns 1020, 1030, 1040. Column 1020 is for fields indicating a specific scenario. In the example, the expected workloads are associated to a ‘Normal’ scenario 1050, a ‘Marketing’ scenario 1060, a ‘Pet's Day’ scenario 1070, and a ‘Black Friday’ scenario 1080. (Black Friday is the day following Thanksgiving Day in the United States, traditionally the beginning of the Christmas shopping season.) Column 1030 is for fields indicating numbers of users associated to a particular scenario. Column 1040 is for fields indicating duration of a particular scenario in the format DAYS(d) HOURS(h) MINUTES(m).

‘Run’ buttons 1090 allow a requester to cause execution of process flow 500 for a specific scenario. ‘Behavior’ buttons 1100 give access to a test requester to a GUI for specifying behavior of user in a particular scenario, as further detailed below with respect to FIG. 10B. An ‘Estimated costs’ button 1110 gives access to a test requester to a GUI displaying calculated costs, as further detailed below with respect to FIG. 10C. An ‘Add scenario’ button 1120 allows a test requester to add a further scenario by inserting a further editable row in table 1010.

Looking ahead to FIG. 10B, GUI 1130 is an example of a GUI for defining a user behavior associated to a particular scenario. In the illustrated example, GUI 1130 is for defining a user behavior associated to the scenario ‘Marketing.’ GUI 1130 includes a table 1140 with columns 1150, 1160, Column 1150 is for fields indicating a user behavior type. In the example, the indicated user behavior types are ‘Browse’ 1170, ‘Browse&Buy’ 1180, and ‘Registering’ 1190. A browse behavior type ‘Browse’ corresponds to users using the application merely for browsing product information. A browse behavior type ‘Browse&Buying’ corresponds to users using the application for browsing product information and buying a product. A browse behavior type ‘Registering’ corresponds to users registering for using the application. Column 1160 is for fields indicating percentage of users addressing the application with the associated behavior. It will be understood that each of the behavior types correspond to a different expected workload of an application.

Continuing with FIGS. 5 and 6, step 502 may include a sub-step 604 of defining a set of workloads including a first workload lower than an expected workload. In an example, testing engine 202 may define a set of test workloads that facilitate automatically determining at least one parameter for executing an application in a cloud computing system under the expected workload. Generally, the set of workloads is chosen such that anomalies that may affect execution of the application under the expected workload can be detected. In one example, the workload set include workloads that increase from a first workload to the expected workload, as further detailed below with respect to FIG. 7 and FIG. 8A. It will be understood that other types of workload sets are contemplated. For example, the set of workload may include a set of aleatory workloads or a set of pre-determined critical workloads (i.e., workloads that are a priori known to probably cause anomalies in the execution of the application).

Step 502 may include a sub-step 606 of causing execution of the application in a cloud computing system under a set of test workloads. In an example, testing engine 202 causes workload generators 400 to generate a workload of a defined set of workloads. Testing engine 202 may assign virtual users and workload generator to specific scenarios. Each virtual user may be associated to a specific behavior. Workloads generators 400 may then generate a workload on the application running in cloud 100 according to the assignment from testing engine 202.

Step 502 may include a sub-step 608 of monitoring execution of the application. In an example, anomaly determination engine 204 monitors execution of an application in cloud 100 under a workload generated by workload generators 400. Sub-step 608 may include monitoring different components of the application such as, but not limited thereto, firewalls, load balancers, web servers, application servers, or database servers as well as individual instances of each component such as, but not limited to, individual VMs virtualizing components in the cloud computing system. Monitoring may further include determining values associated to different metrics of the monitored components. Such values may include, among others, response time, CPU utilization, memory utilization, or latency time.

Step 502 may include a sub-step 610 of ascertaining whether an anomaly occurs. In an example, anomaly determination engine 204 evaluates metrics acquired during monitoring. Anomaly determination engine 204 may ascertain that an anomaly occurs when a metric value sufficiently deviates from a pre-set value associated to normal execution of the application. It will be understood that other methods of performing sub-step 610 are contemplated. For example, an anomaly may be detected using a pre-determined metric normal behavior; a monitored metric may be assigned an abnormal behavior when sampled values thereof deviates from the metric normal behavior; the significance may be then calculated for a monitored metric assigned abnormal; finally, an anomaly may be determined based on the significance of the abnormal metric.

It will be understood that some of the sub-steps 602 to 610 may be not necessarily performed by system 200. In an example, determination host system 116 is operatively coupled to a workload controller (not shown). The workload controller is configured to perform sub-steps 602 to 608. For example, the workload controller may be a system configured to execute HP Load Runner Software (Hewlett-Packard Co., USA, Ca) for automatically test an application executed in a cloud computing system. Further, sub-step 610 may be executed in conjunction with an anomaly determination device (not shown) coupled to determination host system 116. The anomaly determination device may generate a signal associated to an anomaly in the execution of the application in a cloud computing system. Determination host system 116 may receive and process the anomaly signal to ascertain, through anomaly determination engine 204, whether a workload of the workload set causes an anomaly associated to execution of the application in cloud 100.

Continuing with FIG. 5, at step 504, the result of step 502 is evaluated to decide the further procedure in process flow 500. Step 504 may be performed by anomaly determination engine 204. If it is determined that an anomaly occurred, process flow 500 go to step 506. If it is determined that no anomaly occurred, process flow 500 goes back to step 502, which is then repeated for another workload of the workload set. Alternatively, process flow 500 may be finalized.

At step 506, an action from a plurality of actions is determined for addressing an anomaly determined at step 502. Referring to FIG. 2, parameter determination engine 206 may be responsible for implementing step 506. Generally, parameter determination engine 206 determines a value of at least one parameter for executing the application using the determined action. The action for addressing the anomaly may be determined using a pre-determined association between anomalies and actions for solving the anomalies, e.g., a relational data base relating anomalies with actions.

Alternatively, the action for addressing the anomaly may be determined by establishing on the fly an action for addressing a determined anomaly. For example, according to an example, which is further illustrated below with respect to FIG. 7, determining the action includes (i) sequentially testing actions selected from a plurality of actions for execution of the application in the cloud computing system, and (ii) determining whether a selected action solves the anomaly.

According to another example, determining the action includes using a trained classifier relating (i) a quantified metric associated to an anomaly and (ii) a result of performing an action for addressing the anomaly. The action may be determined based on the likelihood than a specific action solves the anomaly. That likelihood may be calculated through the trained classifier. Examples of trained classifiers that may be used includes K-nearest neighbor classifiers, support vector machine classifiers, or Bayesian network classifiers. Identifying an action for addressing the anomaly may include selecting an action from a plurality of actions, each action of the plurality of actions being associated to a cost value. The selected action may then correspond to the action from the plurality of actions with a higher likelihood of sowing the action at a minimum cost.

Once step 506 is finalized and an action for addressing the anomaly is determined, steps 502, 504, and 506 may be repeated for another workload of the workload set following a closed-loop 507. For example, the process depicted in FIG. 5 may be performed for all the workloads in the workload set. Thereby a plurality of anomalies may be determined as well as respective actions for addressing the determined anomalies.

Alternatively, once step 506 is finalized, a cost of executing the application under the expected workload using the determined action (or actions) for preventing the anomaly (or anomalies) may be calculated at step 508. Referring to FIG. 2, cost calculation engine 218 may be responsible for implementing step 508. Step 506 may include determining values of parameters for executing the application using determined actions. Cost calculation engine 218 may use a pre-determined association between values of parameters for executing the application in cloud 100 and related costs. Cost calculation engine 218 may send a request to a provider of services in cloud 100 for obtaining costs of executing the application according to values of the determined parameters for executing the application.

According to some examples, calculating the cost of executing the application includes calculating the cost of executing the application during a selected period of time and for a mixture of expected scenarios. Thereby, it is facilitated a realistic estimation of costs associated to execution of the application in a specific cloud computing system. According to some examples, calculating the cost of executing the application includes calculating a cost per user. Thereby, it is facilitated planning of the requirements posed by executing the application with parameter values that prevent determined anomalies.

According to some examples, process flow 500 may be performed for a plurality of expected workloads. For example, a plurality of workloads may be defined, each of the expected workloads being associated to an expected scenario (see FIG. 10A for an example of different scenarios). Each of steps 502 to 508 may be then performed for each expected workload. At step 508, a cost associated to a respective scenario may be calculated.

Process flow 500 may, optionally, further include a step (not shown) of causing displaying the calculated costs for a test requester. For example, cost calculation engine 218 may cause determination host system 116 to send result data 130 to test request system 120. A GUI at test request system 120 may display data associated to the cost calculation. Alternatively, determination host system 116 self may run such a GUI. Looking ahead to FIG. 100, a GUI 1200 is an example of a GUI for displaying information associated to a cost calculation as described herein. GUI 1200 specifically show a cost overview of an automatically planned cost of executing a E-commerce shop application related to products for pets with the expected workloads defined in the example in FIGS. 10A and 10B.

GUI 1200 includes a ‘Summary’ field 1210 displaying an average cost per user 1212 and an average cost per transaction 1214. GUI 1200 further includes a ‘Planning’ field 1220 displaying an editable ‘Expected load’ field 1222 in users per hour units, a ‘Calculated cost per user’ field 1224, a ‘Calculated hourly cost’ field 1226, and a ‘Calculated monthly cost’ field 1228. Editable ‘Expected load’ field 1222 allows a test requester to enter a value of users per hour and obtain, through field 1224, 1226, 1228, a guess of costs associated to that expected load. The association between the value entered in field 1222 and the values entered in fields 1224, 1226, 1228 may be performed by extrapolating the results obtained in a process as described herein. ‘Planning’ field 1220 also includes an editable ‘Monthly maximum budget’ field 1230 and a ‘Calculated load based on budget’ field 1232. Editable ‘Monthly maximum budget’ field 1230 allows a test requester to enter a value of a maximum available budget and obtain, through field 1232, a guess of load that such a budget can sustain.

GUI 1200 further includes a ‘Learned scaling rules’ field 1240. Field 1240 displays a list 1242 of anomalies detected during cost planning, a list 1244 of infrastructure state during the anomaly, and a list 1246 of actions that are determined to address the anomalies. Field 1240 displays three anomalies relating to execution of process associated to the tested application. A first anomaly corresponds to the process ‘CompFood.aspx’ being slow. The infrastructure state associated to this anomaly is that (i) a logic server running the process does not work properly, as indicated by the label ‘Wrong’, and (ii) a web server running the process works properly, as indicated by the label ‘Ok’. The action determined to solve this anomaly is adding a logic server. A second anomaly corresponds to the process ‘ViewPet.aspx’ being slow. The infrastructure state associated to this anomaly is that a web server running the process does not work properly, as indicated by the label ‘Wrong,’ The action determined to solve this anomaly is increasing the size of a VM running the web server. A third anomaly corresponds to (i) the process ‘CompFood.aspx’ being unavailable, and (ii) the process ‘Login.aspx’ being slow. The infrastructure state associated to this anomaly is that (i) a database associated to these processes does not work properly, as indicated by the label ‘Wrong’, (ii) a logic server running these processes works properly, as indicated by the label ‘Ok’ and (iii) a web server running these processes works properly, as indicated by the label ‘Ok.’ The action determined to solve this anomaly is adding an instance of the database.

GUI 1200 further includes a graph 1250 that displays using a pie chart the fractions of costs associated to each of the scenarios defined for planning the costs. In this example, a normal load scenario accounts for 74% of the costs; a marketing scenario accounts for 6% of the costs; a Pet's Day scenario accounts for 9% of the costs, and a Black Friday scenario accounts for 11% of the costs. GUI 1200 further includes a scenario field 1260 displaying, for each scenario, a graph 1262 showing the usage characteristics of the scenario, more specifically, number of users distributed over time. Scenario field 1260 further includes, for each scenario, a slide bar 1264 enabling a test requester to input a number of day associated to each scenarios. Graphs 1250 and 1262 are updated in consideration of the position of slide bars 1264.

FIG. 7 is a process flow diagram illustrating a process flow 700. Process flow 700 corresponds to a specific implementation of the method in FIG. 5. In the following, process flow 700 is described with reference to elements depicted in FIGS. 8A and 8B. FIG. 8A shows a graph illustrating an example of a workload 802 varying during execution of process flow 700 as well as an example of a variation of a monitored metric 804 during an example of execution of process flow 700. Metric 804 is monitored for determining whether a specific workload causes an anomaly. FIG. 8B is a table 810 showing events taking place during an example of execution of process flow 700.

At step 702, an initial workload 806 is set. Workload 806 forms part of a workload set and is lower than an expected workload 808. By way of example, initial workload 806 corresponds to a number of users lower than the number of users in the expected workload and having the same user behavior and time of use. Initial workload 806 may be chosen sufficiently low such that the likelihood that a still lower workload causes an anomaly is negligible. Thereby, it is facilitated a detection of possible anomalies affecting execution of the application. In the illustrated example, the workload set is comprised of workloads between initial workload 806 and expected workload 808. Step 702 may be performed by testing engine 202, which may cause workload generators 400 to generate workload 600 on an application being executed in cloud 100.

At step 704, it is decided whether a workload (at this stage, initial workload 806) causes an anomaly. This step may be performed by anomaly determination engine 204 in a manner analogous as that described above with regard to steps 502, 504 of the process flow 500 in FIG. 5. If it is decided that the workload does not cause an anomaly, process flow 700 goes to step 712 so as to increase workload (i.e., step 714) or, if all the workloads in the workload set have, been tested, terminate process flow 700. For example, as illustrated at the portion of FIG. 8A between the beginning of the process flow and event A, workloads between initial workload 806 and workload 812 do not cause any anomaly (as indicated by metric 804 remaining at a normal level 814). Therefore, following closed-loop 718, varying workload 802 is steadily increased between initial workload 806 and workload 812.

If it is decided that the workload causes an anomaly, a sequential test of actions for determining whether a selected action solves the anomaly is performed at step 706. This situation arises at event A of the graph in FIG. 8A, as indicated by metric 804 rising to an abnormal value 818). For example, metric 804 may correspond to a response time of a process associated to the application (e.g., a process for computing values of a variable to be displayed on a web server according to certain user inputs). The detected anomaly of event A may be associated to a response time above a pre-determined maximum response time, e.g., eight seconds.

At step 708, an action is selected from a plurality of actions. In the example illustrated in FIGS. 8A and 8B the plurality of actions include increasing the size of a web front server, increasing the size of a logic server, and adding a logic server. It will be understood that the plurality of actions may include any action that may address an anomaly in the execution of an application in a cloud computing system. Step 708 may be implemented by parameter determination engine 206. It will be understood that each action is associated with a particular set of parameter values for executing the application.

At step 710 it is decided whether the action selected at step 708 solves the anomaly. Step 710 may be performed by anomaly determination engine 204. For example, testing engine 202 may cause execution of the application using the selected action and anomaly determination engine 204 may determine whether a metric monitored as having abnormal values at step 704 goes back to normal values due to the selected action. If it is determined that the action selection at step 708 does not solve the anomaly, process flow 700 may go back to step 708, following closed loop 709, and select another action. If it is determined that the action selected at step 708 solves the anomaly, process flow 700 goes to step 712.

Sequential testing at step 706 is illustrated at the portion of FIG. 8A between events A and E. Event A is detecting an anomaly caused by an abnormal rise of metric 804 to an abnormal level 814. Event B is selecting an action, namely increasing the size of a web front server associated to execution of the application. Subsequently, it is determined that this action does not solve the anomaly, as illustrated by metric 804, which remains at abnormal level 816 after event B. Event C is selecting another action, namely increasing the size of a logic server associated to execution of the application. Subsequently, it is determined that this action does not solve the anomaly, as illustrated by metric 804, which remains at abnormal level 816 after event C. Event D is selecting yet another action, namely adding a logic server associated to execution of the application. As elucidated by the decrease of metric 804 after event E, this action solves the anomaly. Event E is determining that the action associated to event D solves the anomaly as illustrated by metric 804, which falls back to normal level 814.

Referring back now to FIG. 7, step 710 (i.e., deciding whether an action selected at step 708 solves an anomaly established at step 704) may include verifying that a selected action solves an anomaly. Verifying may include (i) undoing the action that was determined to solve the anomaly, (ii) subsequently determining whether the anomaly solved by the undone action recurs, (iii) subsequently re-selecting the action that was determined to solve the anomaly, and (iv) determining whether re-selecting the action solves the anomaly.

This is illustrated in the graph in FIG. 8A between events F and I. Event F is undoing the action which was determined to solve the anomaly, namely removing a logic server associated to execution of the application. Event G is determining that the anomaly solved by the undone action recurs. Event H is subsequently re-selecting the action that was determined to solve the anomaly, namely adding a logic server associated to execution of the application. As elucidated by the decrease of metric 804 after event H, this action, again, solves the anomaly. Event I is determining that the action associated to event D solves the anomaly as illustrated by metric 804, which falls back to normal level 814.

According to some examples herein, the order for sequentially testing actions is selected based on a likelihood P that an action solves the anomaly and a cost associated to the action. For example, each action may be associated to a cost function F. The cost function F may have one or more of the following variables: (a) an actual monetary cost $ of performing an action, (b) a time T required for performing the action, and (c) a risk R of taking the action. The cost function may be a normalized function, i.e., a function taking values between 0 and 1.

Further, each action may be associated to a trained classifier relating (i) a quantified metric associated to an anomaly and (ii) a result of performing an action for addressing the anomaly. A likelihood P that the action solves the anomaly may be calculated using the trained classifier. Examples of trained classifiers that may be used include K-nearest neighbor classifiers, support vector machine classifiers, or Bayesian network classifiers.

Once an anomaly is detected, a likelihood P of solving the anomaly may be calculated for each action. Further, for each action a score S may be calculated based on the likelihood P and a normalized cost function F[S, T, R]. For example, a score S may be calculated according to the following relationship: S=P(1−F[$, T, R]) , i.e., the higher the likelihood, the higher the score S is; the higher the cost, the lower the score S is. Then, the actions may be ordered according to the score: actions with a higher score will be selected first for the sequential test. Such ordering of actions facilitates finding an appropriate action that solves the anomaly. It should be noted that testing whether an action solves an anomaly may incur in monetary costs caused by usage of cloud resources as well as in a time consuming procedure.

Referring back to FIG. 7, after it is established at step 710 that an anomaly is solved, process flow 700 goes to step 712, wherein it is decided whether the actual workload corresponds to the standard workload. If the actual workload does not correspond to the standard workload, the workload is increased and process flow goes back to step 704, through closed-loop 718, so as to determine whether the new workload causes an anomaly and further proceed as described above. This is illustrated in the graph in FIG. 8A between event I and the end of the graph, where varying workload 802 is successively increased from workload 812 to expected workload 808 without detecting any further anomaly.

If the actual workload corresponds to the standard workload, process flow 700 exits closed-loop 718 and goes to step 716. This situation arises at the end of the graph shown in FIG. 8A. At step 716, a cost of executing the application under the expected workload using the determined action (or actions) for preventing anomaly may be calculated analogously as calculated at step 508.

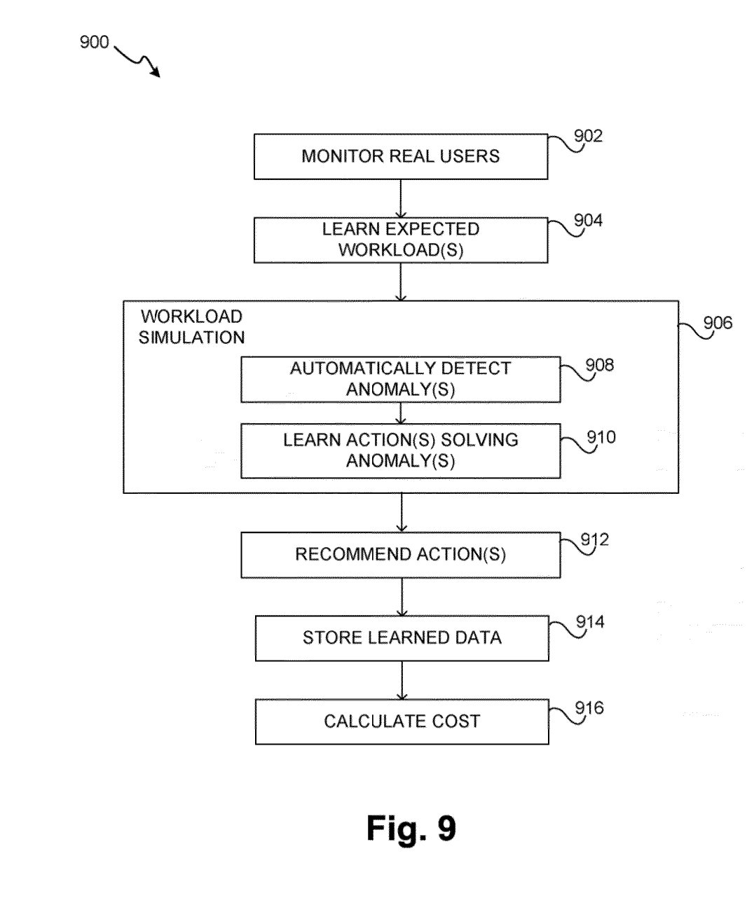

FIG. 9 is a process flow diagram illustrating a process flow 900. Process flow 900 corresponds to a specific implementation of the method in FIG. 5. At step 902, the behavior of real users is monitored. Step 902 may be performed by testing engine 202. For example, testing engine 202 may cause determination host system 116 to send monitoring request packets 126 to cloud 100 in order to request monitoring information associated to interaction of users 110 with a particular application being executed in 100. This monitoring information may include values of metrics associated to users 110 such as, but not limited to, number of users, time of use, or user behavior. Determination host system 116 may then receive monitoring information packets 128 including the requested monitoring information. Testing engine 202 may then process monitoring information packets 128 to extract relevant information for performing step 902.

At step 904, an expected workload is learned. Generally, the monitoring information obtained at step 902 is used to learn the expected workload. Learning the expected workload may include determining specific aspects of a workload such as, but not limited to, number of users, time of use, and user behavior. At step 904, a plurality of expected workloads may be learned. Each of the plurality of expected workloads is associated to an expected scenario. In that case, the further steps of process flow 900 may be performed for the plurality of expected workloads. Determination host system 116 may perform step 904 by processing of monitoring information packets 128.

At step 906, a workload simulation is performed in order to automatically learn actions that may affect executing an application in a cloud computing environment under an expected workload. Step 906 may include a sub-step 908 of automatically detecting anomalies that may affect executing an application in a cloud computing environment under an expected workload. Sub-step 908 may be implemented by executing the application in a cloud computing system under a set of test workloads and detecting anomalies produced by workloads of the workload set, analogously as described above with respect to FIGS. 5 to 8B.

Step 906 may include a sub-step 910 of learning actions for solving anomalies detected at sub-step 908. Sub-step 908 may be implemented by sequentially testing actions and determining whether a selected action solves the anomaly, analogously as described above with respect to FIG. 7 (see step 706).

Process flow 900 may include a step 912 of recommending an action for solving a specific anomaly. For example, parameter determination engine 206 may determine a set of actions for solving specific anomalies. Parameter determination engine 206 may then cause determination host system 116 to send a result 130 to test request system 120 as a response to a previous test request 118. Result 130 may then include information related to actions for solving the specific anomalies that may arise during the execution of a specific application in cloud 100. This information may be displayed through a GUI at test request system 120 (see, e.g., ‘Learned scaling rules’ field 1240 in FIG. 10C).

Process flow 900 may include a step 914 of storing learned data. For example, action determination engine 206 may cause determination host system 116 to store learned data in data store 210. This data may include any of workload data 208, anomaly data 212, action data 214, or parameter data 216. Thereby, a knowledge database may be built which facilitates not only a cost estimation that takes into account an appropriate sizing of the application, but also addressing anomalies that may affect execution of the application during real-life deployment.

Process flow 900 may include a step 916 of calculating costs using the learned data. The cost calculation may take into account the learned actions so as to provide a cost of executing the application with parameters that prevents the occurrence of anomalies. Step 916 may be implemented analogously to step 508 shown in FIG. 5. Step 916 may be performed for multiple expected workloads, each of the expected workload being associated to respective set of actions for preventing occurrence of anomalies.

### CONCLUSION

FIGS. 1-4 aid in depicting the architecture, functionality, and operation of various embodiments. In particular, FIGS. 2-4 depict various physical and logical components. Various components illustrated in FIG. 2-4 are defined at least in part as programs, programming, or program instructions. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagrams in FIGS. 5 to 7 and 9 show specific orders of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

In the foregoing description, numerous details are set forth to provide an understanding of the examples disclosed herein. However, it will be understood by those skilled in the art that the examples may be practiced without these details. While a limited number of examples have been disclosed, those skilled in the art will appreciate numerous modifications and variations therefrom. It is intended that the appended claims cover such modifications and variations as fall within the true spirit and scope of the disclosed examples.

What is claimed is:

1. A method for automatically planning costs of executing an application in a cloud computing system, the method comprising:
determining whether a workload causes an anomaly associated to the execution of an application in a cloud computing system under a set of test workloads including a first workload lower than an expected workload;
upon determining that execution of the application under a workload of the workload set causes an anomaly, automatically determining an action for execution of the application in the cloud computing system, the action being for addressing the anomaly; and
calculating a cost of executing the application under the expected workload using the determined action.

2. The method of claim 1, wherein determining the action includes:
sequentially testing actions selected from a plurality of actions for execution of the application in the cloud computing system; and
determining whether a selected action solves the anomaly.

3. The method of claim 2, wherein the order for sequentially testing actions is selected based on a likelihood that an action solves the anomaly and a cost associated to the action.

4. The method of claim 1, wherein:
executing the application under a set of test workloads includes increasing workload of the application from the first workload to the expected workload;
determining whether a workload of the workload set causes an anomaly is performed during the workload increase and for a plurality of test workloads of the workload set;
determining an action is performed for each determined anomaly;
calculating a cost is performed using all the determined actions.

5. The method of claim 1, further including defining a plurality of expected workloads, each of the expected workloads being associated to an expected scenario, wherein the method is performed for the plurality of expected workloads.

6. The method of claim 5, wherein calculating the cost of executing the application includes calculating the cost of executing the application during a selected period of time and for a mixture of expected scenarios.

7. The method of claim 1, wherein the expected workload of the application includes a number of users of the application and a time of use.

8. The method of claim 7, wherein an expected workload of the application includes a user behavior.

9. The method of claim 1 wherein:
executing the application includes monitoring the execution of the application; and
determining whether a workload of the workload set causes an anomaly includes determining whether the monitored execution corresponds to an anomaly.

10. The method of claim 1, wherein executing the application in a cloud computing system includes executing the application in a sandbox environment.

11. The method of claim 1, wherein calculating the cost of executing the application includes calculating a cost per user.

12. A system for automatically determining at least one parameter for executing an application in a cloud computing system, the system including a testing engine, an anomaly determination engine, and an parameter determination engine, wherein:
the testing engine is to cause execution of the application in a cloud computing system under a set of test workloads including a first workload lower than an expected workload;
the anomaly determination engine is to determine whether the workload set causes an anomaly associated to the execution of the application; and
the parameter determination engine is to, upon the anomaly determination engine determining that execution of the application under a workload of the workload set causes an anomaly, determine a value of at least one parameter associated to execution of the application in the cloud computing system, the value of the at least one parameter being for addressing the anomaly.

13. The system of claim 12, wherein the parameter determination engine is configured to determine the value of the at least one parameter by sequentially testing actions selected from a plurality of actions.

14. The system of claim 12, further comprising a cost calculating engine configured to calculate a cost of executing the application under the expected workload using the determined value of the at least one parameter.

15. A computer readable medium comprising instructions that when executed implement a method for identifying an action for responding to an anomaly in the execution of an application, the method including:
causing execution of the application in a cloud computing system under a set of test workloads including a workload lower than an expected workload;
determining whether a workload of the workload set causes an anomaly associated to the execution of the application; and
upon determining that execution of the application under a workload of the workload set causes an anomaly, determining an action from a plurality of actions for addressing the anomaly by:
sequentially testing actions selected from the plurality of actions; and
determining whether a selected action solves the anomaly.
